(19) United States
(12) Patent Application Publication
(10) Pub. No.: US 2026/0246402 A1
(43) Pub. Date: Aug. 20, 2026

(54) ROTATIONAL SPEED ESTIMATION METHOD AND CONTROL DEVICE FOR BRUSHLESS DC MOTOR

(71) Applicants: SHINSHU UNIVERSITY, Matsumoto City (JP); SHINANO KENSHI CO., LTD., Ueda-shi (JP)

(72) Inventors: Yuichi CHIDA, Nagano City (JP); Masaya TANEMURA, Nagano City (JP); Naoto MUTO, Nagano City (JP)

(21) Appl. No.: 19/427,984

(22) Filed: Dec. 19, 2025

(30) Foreign Application Priority Data
Feb. 19, 2025 (JP) 2025-025112

(51) Int. Cl. H02P 6/17

(52) U.S. Cl. CPC H02P 6/17

(57) ABSTRACT

A rotational speed estimation method for a brushless DC motor includes: an extended particle filter setting step of setting, to the extended particle filter, a plurality of likelihoods including a first likelihood and a second likelihood selectively applied based on whether a change occurs in output of a plurality of magnetic sensors of a rotor; a detection pulse signal acquisition step of acquiring a detection pulse signal output from each of the plurality of magnetic sensors; a signal processing step of obtaining a continuous pulse from the detection pulse signal; and a rotational speed estimation step of using the extended particle filter, applying the first likelihood as the likelihood when no change occurs in the continuous pulse and applying the second likelihood when a change occurs in the continuous pulse, and estimating the rotational speed of the rotor.

### CROSS-REFERENCE TO RELATED APPLICATION

This application is based on and claims priority to Japanese Patent Application No. 2025-025112 filed on Feb. 19, 2025, the entire disclosures of which are hereby incorporated by reference herein.

### BACKGROUND OF THE INVENTION

### 1. Field of the Invention

The present invention relates to a rotational speed estimation method for a brushless DC motor and a control device for the brushless DC motor using the rotational speed estimation method.

### 2. Description of the Related Art

Brushless DC motors are widely used in various fields, such as industrial products and computer peripherals, because of their simple configuration and good controllability. Brushless DC motors are usually used while being controlled so that the rotational speed matches a desired rotational speed with a rotary encoder that detects the rotational speed. Meanwhile, it is desired for brushless DC motors to have a smaller size and weight and be manufactured at a lower cost, and there have been developed methods that do not require a rotary encoder. Among these methods, one practically used method is a method that observes and estimates the rotational speed based on output signals from Hall sensors instead of a rotary encoder. In the observation and estimation method based on the output signals from Hall sensors, however, the frequency of detection of the magnetic poles decreases during low-speed rotation of the brushless DC motor, resulting in a long period of time when the rotational speed fails to be observed. Thus, the deterioration of estimation accuracy during low-speed rotation is a problem to be solved. To address this issue, methods have been developed for improving the estimation performance during low-speed rotation when low-resolution output signals, such as the output signals from Hall sensors, are used.
Non-patent Literature 1 discloses a method that uses a Model Reference Adaptive Control(MRAC)-based estimator. Non-patent Literature 2 discloses a method that combines a Kalman filter and a sliding observer.
(Non-patent Literature 1) Yang Liu, Jin Zhao, Mingzi Xia, Hui Luo, “Model reference adaptive control-based speed control of brushless DC motors with low-resolution Hall-effect sensors,” IEEE Transactions on Power Electronics 2014, 29, 1514-1522
(Non-patent Literature 2) Y. Buchnik and R. Rabinovici, “Speed and position estimation of brushless DC motor in very low speeds,” 2004 23rd IEEE Convention of Electrical and Electronics Engineers in Israel, Tel-Aviv, Israel, 2004, pp. 317-320

### SUMMARY OF THE INVENTION

While the methods disclosed in Non-patent Literature 1 and Non-patent Literature 2 are effectively used to improve the estimation performance during low-speed rotation, they use a detected current value in a motor circuit to perform the estimation. There has been a demand to perform estimation without using any current signals from the viewpoint of cost reduction and wiring simplification.

In view of the circumstances described above, a main object of the present invention is to provide a rotational speed estimation method for a brushless DC motor that enables estimating the rotational speed of the brushless DC motor with high accuracy from the time of low-speed rotation based on information obtained by observation by magnetic sensors, such as Hall sensors, without using a rotary encoder or a detected current value. In addition, an object of the present invention is to provide a control device that can control, by using the rotational speed estimation method, a brushless DC motor to follow a target rotational speed with high accuracy from the time of low-speed rotation based on information obtained by observation by magnetic sensors without using a rotary encoder or a detected current value.

To solve the problem described above, a rotational speed estimation method for a brushless DC motor according to the present invention is a method for estimating an actual rotational speed of a rotor by passing an output of a plurality of magnetic sensors, which detect the magnetic poles of the rotor through a filter.

This method includes: an extended particle filter setting step of using an extended particle filter to which a plurality of likelihoods is capable of being set as the filter, and setting, as the likelihoods, at least a first likelihood and a second likelihood, which are selectively applied based on whether a change occurs in the output of the magnetic sensors to the extended particle filter, the first likelihood being adapted to a case where no change occurs in the output of the magnetic sensors and the second likelihood being adapted to a case where a change occurs in the output of the magnetic sensors; a detection pulse signal acquisition step of acquiring a detection pulse signal output from each of the magnetic sensors at a predetermined sampling period; a signal processing step of obtaining a continuous pulse by exclusive-ORing (XORing) the detection pulse signal acquired at each sampling time; and a rotational speed estimation step of using the extended particle filter to which the likelihoods are set, applying the first likelihood as a likelihood of the extended particle filter when no change occurs in the continuous pulse and applying the second likelihood as the likelihood of the extended particle filter when a change occurs in the continuous pulse, and estimating a rotational speed of the rotor.

In this method, when an angle of one pulse width of the continuous pulse is resolution, and a state of the motor in which a rotational angle of the rotor is predicted is a predicted state, the first likelihood is designed to be made larger for the predicted state where an amount of rotation of the rotor is smaller than the resolution and made smaller for the predicted state where the amount of rotation of the rotor is equal to or larger than the resolution from a point immediately after a change occurs in the continuous pulse, and the second likelihood is designed to be made smaller for the predicted state where the amount of rotation of the rotor is smaller than the resolution and made larger for the predicted state where the amount of rotation of the rotor is equal to or larger than the resolution from the point immediately after the change occurs in the continuous pulse.

Specifically, in this method, the first likelihood is designed by Expression 8 below, and the second likelihood is designed by Expression 10 below:

$${α}_{k}^{( n )} = \{ \begin{matrix}\begin{matrix}\begin{matrix}\begin{matrix}exp [ - \frac{{\{ {\hat{θ}}_{k \vert k - 1}^{( n )} - ( {\tilde{θ}}^{( n )} - Φ ) \}}^{2}}{2 {σ}^{2}} ] \\ if {\hat{θ}}_{k \vert k - 1}^{( n )} \leq {\tilde{θ}}^{( n )} - Φ ,\end{matrix} \\ 1 if {\tilde{θ}}^{( n )} - Φ < {\hat{θ}}_{k \vert k - 1}^{( n )} < {\tilde{θ}}^{( n )} + Φ ,\end{matrix} \\ exp [ - \frac{{\{ {\hat{θ}}_{k \vert k - 1}^{( n )} - ( {\tilde{θ}}^{( n )} + Φ ) \}}^{2}}{2 {σ}^{2}} ]\end{matrix} \\ if {\hat{θ}}_{k \vert k - 1}^{( n )} \geq {\tilde{θ}}^{( n )} + Φ .\end{matrix} \qquad ( Expression 8 )$$

where
α: likelihood
k: sampling time
n: index of the particle
\hat{θ}: estimated value (predicted value) of the angle
\tilde{θ}: estimated value of the angle at the moment when the signal is updated
Φ: angular resolution
σ: design parameter

$${α}_{k}^{( n )} = \{ \begin{matrix}\begin{matrix}\begin{matrix}\begin{matrix}\begin{matrix}1 if {\hat{θ}}_{k \vert k - 1}^{( n )} \leq {\tilde{θ}}^{( n )} - Φ , \\ exp [ - \frac{{\{ {\hat{θ}}_{k \vert k - 1}^{( n )} - ( {\tilde{θ}}^{( n )} - Φ ) \}}^{2}}{2 {σ}^{2}} ]\end{matrix} \\ if {\tilde{θ}}^{( n )} - Φ < {\hat{θ}}_{k \vert k - 1}^{( n )} < {\tilde{θ}}^{( n )} ,\end{matrix} \\ exp [ - \frac{{\{ {\hat{θ}}_{k \vert k - 1}^{( n )} - ( {\tilde{θ}}^{( n )} + Φ ) \}}^{2}}{2 {σ}^{2}} ]\end{matrix} \\ if {\tilde{θ}}^{( n )} \leq {\hat{θ}}_{k \vert k - 1}^{( n )} < {\tilde{θ}}^{( n )} + Φ ,\end{matrix} \\ 1 if {\hat{θ}}_{k \vert k - 1}^{( n )} \geq {\tilde{θ}}^{( n )} + Φ .\end{matrix} \qquad ( Expression 10 )$$

where
α: likelihood
k: sampling time
n: index of the particle
\hat{θ}: estimated value (predicted value) of the angle
\tilde{θ}: estimated value of the angle at the moment when the signal is updated
Φ: angular resolution
σ: design parameter

In this method, the rotational speed estimation step includes: normalizing the likelihood, sampling with replacement a certain state predicted value from a state predicted value of the predicted state with a probability based on the normalized likelihood, and replacing the certain state predicted value sampled with replacement with a state estimated value of an estimated state; and updating an estimated angle serving as an estimated value of the angle of the rotor at a moment immediately after a change occurs in the continuous pulse.

In this method, when no change occurs in the continuous pulse, the estimated angle is updated by carrying it over to next time at the updating the estimated angle, and when a change occurs in the continuous pulse, the estimated angle is updated by replacing it with the estimated value of the angle at the moment when the change occurs.

To solve the problem described above, a control device for a brushless DC motor according to the present invention is a device coupled to the brushless DC motor including a plurality of magnetic sensors that detect and output the magnetic poles of the rotor, and configured to drive and control the brushless DC motor.

This device includes: a motor driver configured to drive and rotate the rotor at a target rotational speed based on a control command; a detection pulse signal acquirer configured to acquire a detection pulse signal output from each of the magnetic sensors at a predetermined sampling period; a signal processor configured to obtain a continuous pulse by exclusive-ORing (XORing) the detection pulse signal acquired at each sampling time; an extended particle filter designed to have at least a first likelihood and a second likelihood selectively applied based on whether a change occurs in the continuous pulse as a likelihood, and configured to apply the first likelihood as the likelihood when no change occurs in the continuous pulse and apply the second likelihood as the likelihood when a change occurs in the continuous pulse and to estimate a rotational speed of the rotor as an estimated rotational speed; and a motor control commander configured to generate the control command based on the estimated rotational speed estimated by the extended particle filter and the target rotational speed to cause the rotor to follow the target rotational speed and output the control command to the motor driver.

In this device, when an angle of one pulse width of the continuous pulse is resolution, and a state of the motor in which a rotational angle of the rotor is predicted is a predicted state, the first likelihood is designed to be made larger for the predicted state where an amount of rotation of the rotor is smaller than the resolution and made smaller for the predicted state where the amount of rotation of the rotor is equal to or larger than the resolution from a point immediately after a change occurs in the continuous pulse. The second likelihood is designed to be made smaller for the predicted state where the amount of rotation of the rotor is smaller than the resolution and made larger for the predicted state where the amount of rotation of the rotor is equal to or larger than the resolution from the point immediately after the change occurs in the continuous pulse.

Specifically, in this device, the first likelihood of the extended particle filter is designed according to Expression 8 above, and the second likelihood of the extended particle filter is designed by Expression 10 above.

In this device, the extended particle filter is designed to perform: normalizing the likelihood, sampling with replacement a certain state predicted value from a state predicted value of the predicted states with a probability based on the normalized likelihood, and replacing the certain state predicted value sampled with replacement with a state estimated value of an estimated state; and updating an estimated angle, which serves as an estimated value of the rotor angle at a moment immediately after a change occurs in the continuous pulse.

In this device, when no change occurs in the continuous pulse, the extended particle filter updates the estimated angle by carrying it over to next time, and when a change occurs in the continuous pulse, the extended particle filter updates the estimated angle by replacing it with the estimated value of the rotor angle at the moment when the change occurs.

The present invention enables estimating the rotational speed of a brushless DC motor with high accuracy from the time of low-speed rotation based on information obtained by observation by magnetic sensors, such as Hall sensors, without using a rotary encoder or a detected current value.

### BRIEF DESCRIPTION OF THE DRAWINGS

FIG. 1 is a configuration diagram of a motor system according to an embodiment;

FIG. 2 is a signal processing diagram in the motor system according to the embodiment;

FIG. 3 is a diagram for explaining pulse signals based on magnetic sensor signals in the motor system according to the embodiment;

FIG. 4 is a model diagram of a motor used in the embodiment;

FIG. 5 is a flowchart of an estimation algorithm used in the embodiment;

FIGS. 6A and 6B are diagrams of a pattern of the state of a continuous pulse in the embodiment;

FIG. 7 is a diagram of a model of the likelihood when no change occurs in the continuous pulse in the embodiment;

FIG. 8 is a diagram of an estimated angle at the moment immediately after the signal is updated in the embodiment;

FIG. 9 is a diagram of a model of the likelihood when a change occurs in the continuous pulse in the embodiment;

FIG. 10 is a flowchart of processing at a resampling and updating step in FIG. 5;

FIG. 11 is a diagram of time difference in calculating the estimated angle in the embodiment;

FIG. 12 is a flowchart of a control method for the motor according to the embodiment; and

FIG. 13 is a graph indicating the simulation results of estimation of the rotational speed of the motor using an extended particle filter according to an example.

### DETAILED DESCRIPTION OF EMBODIMENTS

A brushless DC motor system 1 is described below as an embodiment of the present invention with reference to the drawings. The drawings do not necessarily accurately reflect all the actual configurations. In the present specification, the term “rotational speed” is used to describe the rotation of a rotor of a brushless DC motor, but it may be replaced by the term “angular velocity”. In the present specification, the structure of the brushless DC motor, the principle of driving the brushless DC motor using an inverter circuit, and peripheral devices used to control the brushless DC motor are substantially the same as those in conventional systems, and explanation of the same parts as those in the conventional systems are simplified or omitted. In the text, a signal represented as a symbol with a superscript “\hat{ }”, such as “ω\hat{ }”, means an estimated or predicted signal, and is represented as a symbol with an umbrella accent (hat) instead of the symbol with the superscript “\hat{ }” in the expressions and figures. In the text, a rotational angle represented as a symbol with a superscript “^{~}”, such as “θ^{~}”, means an estimated value of the rotational angle at the moment immediately after a change occurs in the output of a magnetic sensor, and is represented as a symbol with a wavy bar accent (tilde) instead of the symbol with the superscript “^{~}” in the expressions and figures. In the text, a signal represented as a symbol with a superscript “^{v}”, such as “ω^{v}”, means a re-estimated signal, and is represented as a symbol with an inverted umbrella accent (check) instead of the symbol with the superscript “^{v}” in the expressions and figures. In the text, a likelihood represented as a symbol with a subscript “bar”, such as “α_{bar}”, means a normalized likelihood, and is represented as a symbol with a straight bar accent (bar) instead of the symbol with the subscript “bar” in the expressions. In the present specification, the timing of processing repeatedly performed at a predetermined interval (sampling period) to estimate the rotational speed is referred to as sampling time, and the timing at which the processing is performed is represented as a symbol “k”.

### 1-1. Configuration of a Motor System 1

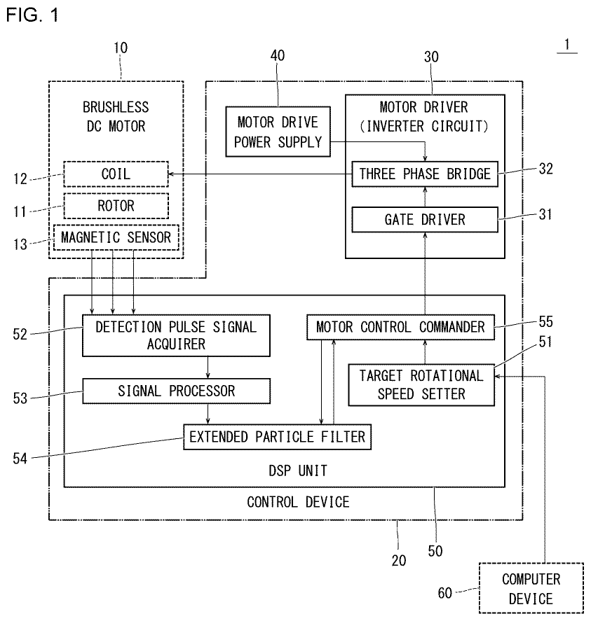

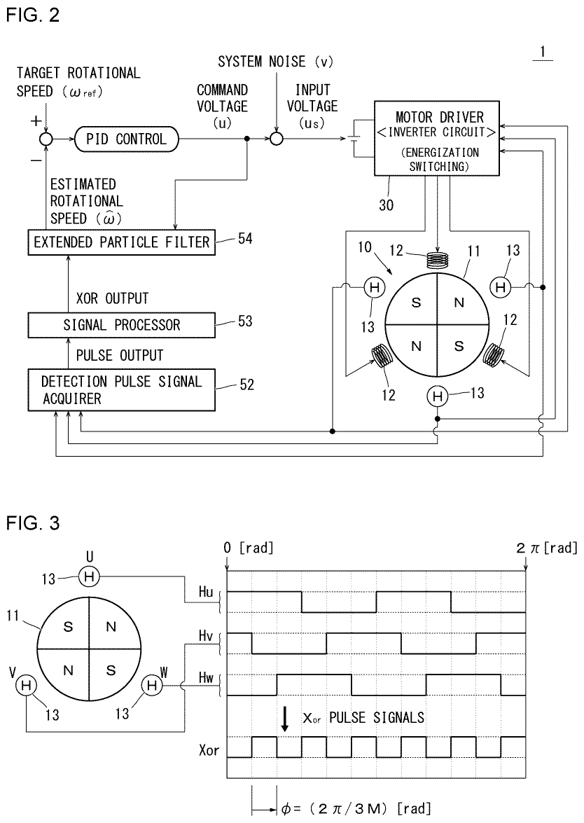

FIG. 1 is a configuration diagram of the brushless DC motor system 1 (hereinafter, simply referred to as a “motor system 1”) according to the embodiment. FIG. 2 is a signal processing diagram in the motor system 1. FIG. 3 is a diagram for explaining the processing of pulse signals detected by magnetic sensors 13 in the motor system 1. First, the configuration of the motor system 1 according to the embodiment is described with reference to FIG. 1 and, as necessary, to FIGS. 2 and 3.

As illustrated in FIG. 1, the motor system 1 includes a brushless DC motor 10 (hereinafter, simply referred to as a “motor 10”) that outputs rotational power and a control device 20 that drives and controls the motor 10 coupled thereto. The motor system 1 also includes a computer device 60 coupled to the control device 20 in a data-exchangeable manner such that it can set data in the control device 20 and acquire data from the control device 20.

The motor 10 includes a stator (not illustrated), a rotor 11, a plurality of coils 12, and a plurality of magnetic sensors 13. The rotor 11 has a plurality of magnetic poles and is rotatable with respect to the stator. The coils 12 are fixed to the stator at equal intervals in the circumferential direction. The magnetic sensors 13 are also fixed to the stator at equal intervals in the circumferential direction. The rotor 11 includes an output shaft and permanent magnets having S-pole and permanent magnets having N-pole, which are arranged at equal intervals in the circumferential direction with respect to the output shaft, and functions as the rotor. The coils 12 can switch between generating the magnetic force of S-pole, generating the magnetic force of N-pole, and generating no magnetic force depending on the presence and direction of a current supplied from a motor driver 30, which will be described later, including an inverter circuit. The magnetic sensors 13 are, for example, Hall sensors and detect the magnetic poles of the rotor 11 facing them. The stator, the coils 12, and the magnetic sensors 13 constitute a stator. The motor 10 is a four-pole three-phase motor with a U-phase, a V-phase, and a W-phase composed of four magnetic poles arranged in the rotor 11 (divided into four equal parts at 90°), three coils 12 (1200 pitch), and three magnetic sensors 13 (1200 pitch). The motor 10 is configured to detect and output the magnetic poles of the rotor 11 by the magnetic sensors 13 arranged at equal intervals.

The control device 20 includes the motor driver 30, a motor drive power supply 40, and a digital signal processor (DSP) unit 50, and is configured to drive and control the motor 10 coupled thereto. While the control device 20 includes other components, such as an AD converter, the other components are known, and explanation thereof is omitted.

The motor driver 30 has an inverter circuit including a gate driver 31 and a three-phase bridge 32. In the motor driver 30, the coils 12 of the motor 10 are coupled to the respective lines of the phases of the three-phase bridge 32. The motor driver 30 controls a command voltage (u) by the gate driver 31 switching the energized phases based on a PID control command from the DSP unit 50, described later, and can drive and rotate the rotor 11 at a target rotational speed (ω_{ref}) (also refer to FIG. 2).

The motor drive power supply 40 is electrically coupled to the motor driver 30 and supplies drive power to the energized phase of the motor 10 via the three-phase bridge 32 of the motor driver 30.

The DSP unit 50 is a processing unit including a storage element, an arithmetic element, and an input/output interface. The storage element stores therein control programs and temporarily stored data. The arithmetic element performs arithmetic processing. The input/output interface is an interface for inputting and outputting data from and to the outside. The DSP unit 50 performs digital signal processing and digital signal input/output processing according to the control programs stored in the storage element. The DSP unit 50 includes a target rotational speed setter 51, a detection pulse signal acquirer 52, a signal processor 53, an extended particle filter 54, and a motor control commander 55, and performs control processing on the motor 10.

The target rotational speed setter 51 receives an input of the target rotational speed (ω_{ref}) for driving the motor 10 from the computer device 60, described later.

The detection pulse signal acquirer 52 acquires detection pulse signals output from the respective magnetic sensors 13 at a predetermined sampling period (also refer to FIG. 3).

The signal processor 53 obtains a continuous pulse (Xₒᵣ) (also refer to FIG. 3) by exclusive-ORing (hereinafter referred to as “XORing”) three terminal inputs of three detection pulse signals acquired by the detection pulse signal acquirer 52 at respective sampling times.

Compared with the conventional particle filter, the extended particle filter 54 is designed to have at least a first likelihood and a second likelihood selectively applied based on whether a change occurs in the continuous pulse (Xₒᵣ) as likelihoods. The first likelihood is adapted to a case where no change occurs in the output of the magnetic sensors 13, and the second likelihood is adapted to a case where a change occurs in the output of the magnetic sensors 13. The extended particle filter 54 is obtained by extending the functionality of the conventional particle filter so as to estimate the rotational speed of the rotor 11 as an estimated rotational speed (ω\hat{ }) by applying the first likelihood as the likelihood when no change occurs in the continuous pulse (Xₒᵣ) and applying the second likelihood as the likelihood when a change occurs in the continuous pulse (Xₒᵣ). The extended particle filter 54 is designed to estimate the rotational speed from the continuous pulses (Xₒᵣ) processed by the signal processor 53 with high accuracy from the time of low-speed rotation. As illustrated in FIG. 2, the extended particle filter 54 receives the command voltage (u) and the continuous pulse (Xₒᵣ) and estimates and outputs the estimated rotational speed (ω\hat{ }) according to design contents, which will be described later. The estimation processing by the extended particle filter 54 will be described later in detail in the section “1-4. Estimation Algorithm” below.

The motor control commander 55 generates a control command based on the estimated rotational speed (ω\hat{ }) estimated by the extended particle filter 54 and the target rotational speed (ω_{ref}) such that the motor 10 follows the target rotational speed (ω_{ref}). The motor control commander 55 outputs the command voltage (u) serving as the generated control command to the motor driver 30.

The computer device 60 is, for example, a personal computer, a tablet terminal device, a mobile terminal device, a control switch, or a display panel. The computer device 60 transmits and receives data to and from the DSP unit 50 to give instructions on the contents of control to be performed by the DSP unit 50, display data acquired from the DSP unit 50, and perform an analysis using the data.

In the motor system 1 configured as described above, the command voltage (u) for PID control is first determined based on the target rotational speed (ω_{ref}) and the estimated rotational speed (ω\hat{ }) estimated by the extended particle filter 54 as illustrated in FIG. 2. While the command voltage (u) is transmitted to the motor driver 30 as the control command, the motor driver 30 actually receives an input voltage (uₛ) obtained by adding a system noise (v) to the command voltage (u). The information on the command voltage (u) is also fed back to the extended particle filter 54 and used to estimate the next estimated rotational speed in the extended particle filter 54. The motor driver 30 that receives the input voltage (uₛ) switches the coils 12 to be energized by the inverter circuit according to it and drives and rotates the motor 10. When the motor 10 is driven to rotate, the magnetic sensors 13 detect the magnetism of the rotor 11. Each detection pulse signal is output to the motor driver 30 to indicate the timing of switching the coils 12 to be energized and to the detection pulse signal acquirer 52. Each detection pulse signal output to the detection pulse signal acquirer 52 is output to the signal processor 53 at the predetermined sampling period, and the continuous pulse (Xₒᵣ) is obtained by XORing the detection pulse signals acquired at the respective sampling times in the signal processor 53. In the motor system 1, the actual rotational speed is estimated from the continuous pulses (Xₒᵣ) as the estimated rotational speed (ω\hat{ }), and the estimated rotational speed (ω\hat{ }) is fed back. The following describes the extended particle filter 54 employed in the motor system 1 to cause the motor 10 to follow the target rotational speed (ω_{ref}) with high accuracy in detail.

### 1-2. Pulse Signals Based on Magnetic Sensor Signals

FIG. 3 is a diagram for explaining pulse signals based on magnetic sensor signals in the motor system 1 according to the embodiment. To explain the design of the extended particle filter 54, the pulse signals based on the output signals from the magnetic sensors 13 are described first with reference to FIG. 3

In acquiring the pulse signals based on the output signals from the magnetic sensors 13, the continuous pulse (Xₒᵣ) is obtained by XORing the pulse signals (Hu, Hv, Hw) acquired by the magnetic sensors 13, which are arranged around the rotor 11, detecting the magnetic poles of the rotor 11 as illustrated in FIG. 3.

The number of magnetic poles of the rotor 11 of the motor 10 is M (FIGS. 2 and 3 illustrate an example where M=4 is satisfied), and the three magnetic sensors 13 and the magnetic poles of the rotor 11 are each arranged in equal phase. Therefore, the distance between adjacent edges of the continuous pulse (Xₒᵣ) corresponds to 2π/3M [rad] rotations of the motor 10. This amount of rotation is defined as the minimum angular resolution (φ) (hereinafter referred to as “resolution (φ)”) expressed by Expression 1 below. In other words, the resolution (φ) is the angle of one pulse width of the continuous pulse (Xₒᵣ). When the amount of rotation of the motor 10 reaches the resolution (φ), the signal level changes (is updated), and a valid continuous pulse (Xₒᵣ) is obtained; and when the amount of rotation of the motor 10 is smaller than the resolution (φ), the signal level does not change (is not updated), and no valid continuous pulse (Xₒᵣ) is obtained (in the following description, the former is described as “a change occurs in the continuous pulse”, and the latter as “no change occurs in the continuous pulse”).

$$Φ = \frac{2 π}{3 M} [ rad ] \qquad ( Expression 1 )$$

where
Φ: angular resolution
M: the number of magnetic poles of the rotor

### 1-3. State Space Model of the Motor 10

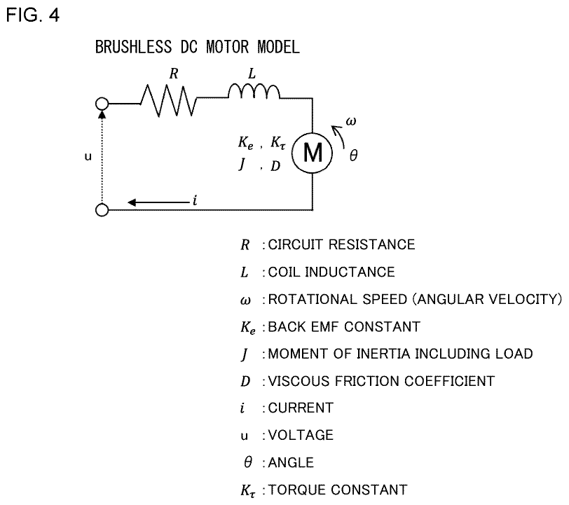

FIG. 4 is a model diagram of the motor 10. The following describes a state space model of the motor 10 serving as a standard for designing the algorithm for the extended particle filter 54. As illustrated in FIG. 4, the state space model of the motor 10 is similar to the model of a typical brushless DC motor. In the model, u is an input voltage, i is a current, ω is a rotational speed, θ is an angle, R is circuit resistance, L is coil inductance, Kₑ is a back EMF constant, K_{τ} is a torque constant, J is moment of inertia including load, and D is a viscous friction coefficient. A continuous-time equation of state derived by a circuit equation and an equation of motion in the motor 10 is expressed by Expressions 2 to 4 below:

$$\dot{x} = {A}_{c} x + {b}_{c} u \qquad ( Expression 2 )$$

provided that

$$x = [ \begin{matrix}\begin{matrix}i \\ ω\end{matrix} \\ θ\end{matrix} ] \qquad ( Expression 3 )$$

$$c = [ \begin{matrix}- \frac{R}{L} & - \frac{{K}_{e}}{L} & 0 \\ \frac{{K}_{τ}}{J} & - \frac{D}{J} & 0 \\ 0 & 1 & 0\end{matrix} ] , {b}_{c} = [ \begin{matrix}\begin{matrix}\frac{1}{L} \\ 0\end{matrix} \\ 0\end{matrix} ] \qquad ( Expression 4 )$$

where
x: state
u: input voltage
i: current
ω: rotational speed
R: circuit resistance
L: coil inductance
Kₑ: back EMF constant
K_{τ}: torque constant
J: moment of inertia including load
D: viscous friction coefficient
A_{c}: coefficient (of the state)
b_{c}: coefficient (of the input voltage)

By discretizing Expression 2 by assuming a sampling period (T) and zero-order hold, the equation of state of the motor 10 is expressed by Expression 5 below, where k is time of a sample point (hereinafter referred to as “sampling time”).

$${x}_{k + 1} = {Ax}_{k} + {bu}_{k} \qquad ( Expression 5 )$$

where
k: sampling time
x: state
u: input voltage
A: coefficient (of the state)
b: coefficient (of the input voltage)

By assuming that normal system noise (vₖ~N(0,σ²ᵥ)) is added to an input (uₖ) in Expression 5, the system model is defined as Expression 6 below:

$${x}_{k + 1} = {Ax}_{k} + {bu}_{k} + {bv}_{k} \qquad ( Expression 6 )$$

where
k: sampling time
x: state
u: input voltage
v system noise
A: coefficient (of the state)
b: coefficient (of the input voltage)

### 1-4. Estimation Algorithm

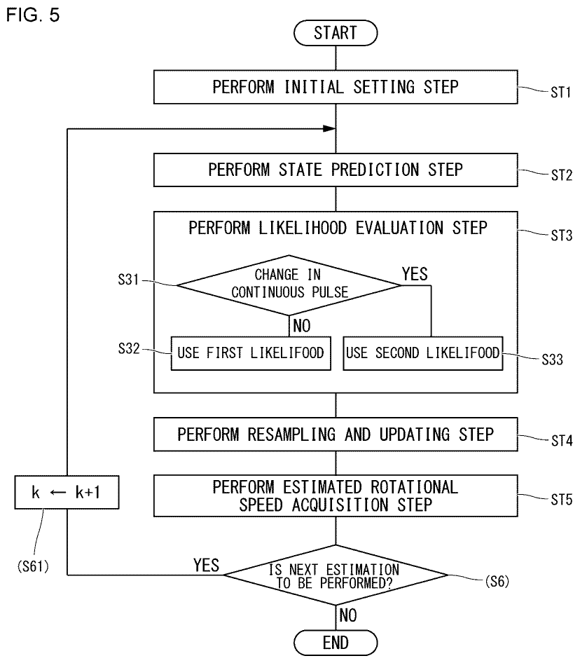

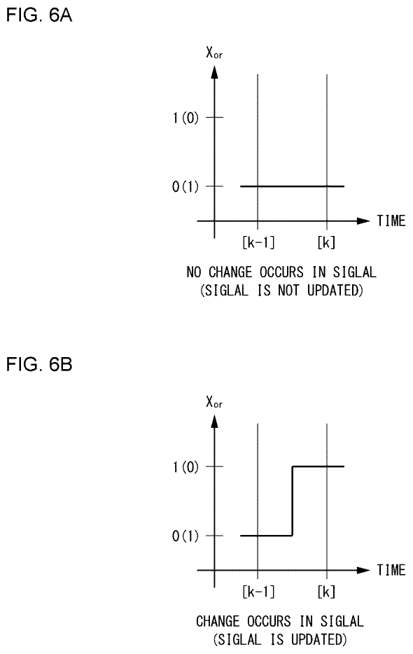

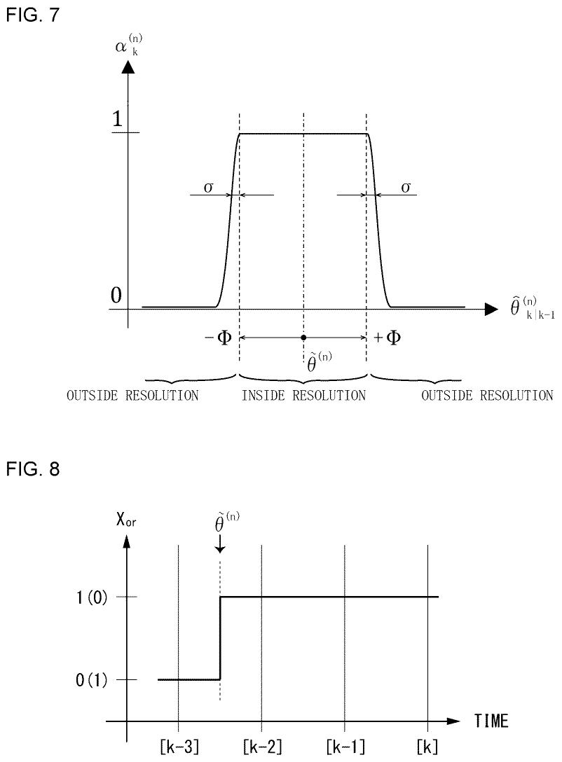

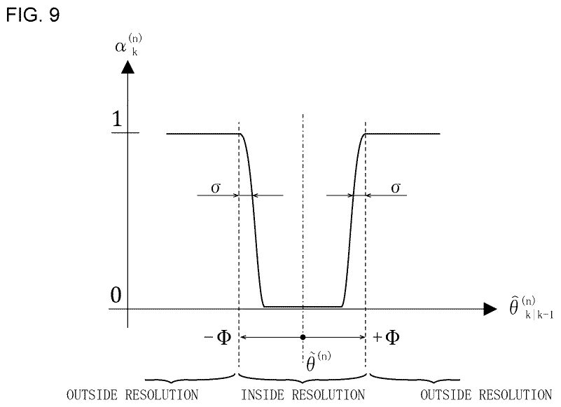

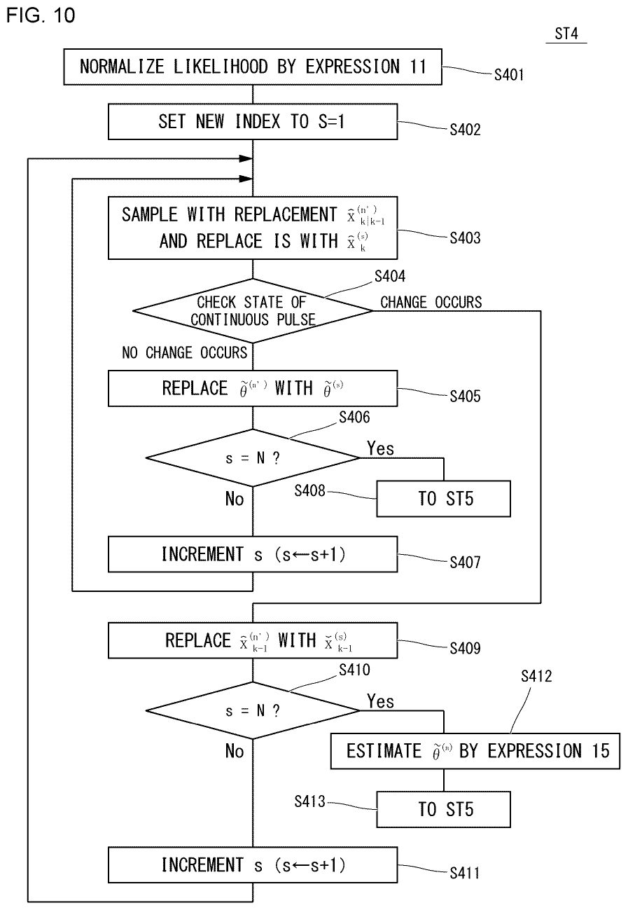

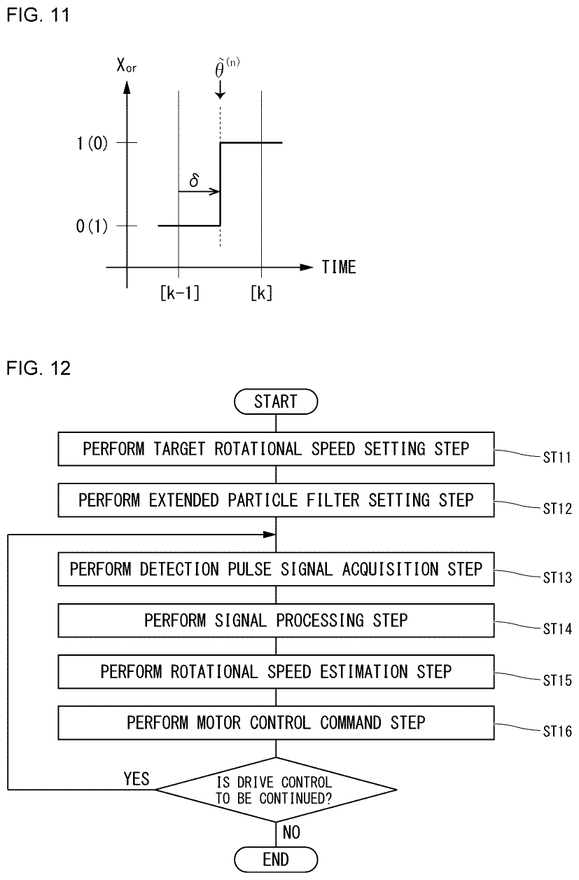

FIG. 5 is a flowchart of an estimation algorithm used in the embodiment. FIGS. 6A and 6B are diagrams of patterns of the state of the continuous pulse (Xₒᵣ). FIG. 6A illustrates a case where no change occurs in the continuous pulse (Xₒᵣ) (not updated), and FIG. 6B illustrates a case where a change occurs in the continuous pulse (Xₒᵣ) (updated). FIG. 7 is a diagram of a model of the likelihood when no change occurs in the continuous pulse (Xₒᵣ). FIG. 8 is a diagram of an estimated angle at the moment immediately after the continuous pulse (Xₒᵣ) changes. FIG. 9 is a diagram of a model of the likelihood when a change occurs in the continuous pulse (Xₒᵣ). FIG. 10 is a flowchart of processing at a resampling and updating step ST4. FIG. 11 is a diagram of time difference (δ) in calculating the estimated angle (θ^{~(n)}). The following describes the estimation algorithm used in the rotational speed estimation method for the motor according to the embodiment with reference to these figures.

The extended particle filter 54 is configured based on the system model defined in Expression 6 and performs an initial setting step ST1, and a state prediction step ST2 and a likelihood evaluation step ST3, which are repeated at a constant sampling period until the drive control of the motor 10 is stopped, as illustrated in FIG. 5. In the following description, the number of particles handled by the extended particle filter 54 (hereinafter referred to as “the number of particles”) is denoted as N, and the index of the particle is denoted as n (n=1, . . . , N). The particle of a predicted state is denoted as x\hat{ }⁽ⁿ⁾_{k|k-1}, and the particle of an estimated state is denoted as x\hat{ }⁽ⁿ⁾ₖ. They predict and estimate the state (xₖ) in Expression 6.

In the extended particle filter 54, the number of particles (N) and an initial value of the estimated state {x\hat{ }₀⁽¹⁾, . . . , x\hat{ }₀^{(N)}} are set at the initial setting step ST1.

Subsequently, the predicted state x\hat{ }⁽ⁿ⁾_{k|k-1} is calculated by Expression 7 below with n=1, . . . , N according to the system model expressed by Expression 6 at the state prediction step ST2. This noise (v⁽ⁿ⁾ₖ₋₁ (~N(0, σ²ᵥ))) is generated by numerical calculation.

$${\hat{x}}_{k \vert k - 1}^{( n )} = A {\hat{x}}_{k - 1}^{( n )} + {bu}_{k - 1} + {bv}_{k - 1}^{( n )} \qquad ( Expression 7 )$$

where
k: sampling time
n: index of the particle
\hat{x}: state estimated value (predicted value)
u: input voltage
v system noise
A: coefficient (of the state)
b: coefficient (of the input voltage)

Subsequently, the likelihood is evaluated based on the continuous pulse (Xₒᵣ) obtained for the predicted state (x\hat{ }⁽ⁿ⁾_{k|k-1}) predicted by Expression 7 at the likelihood evaluation step ST3. The design of the likelihood reflects a characteristic method for improving the estimation performance during low-speed rotation such that the continuous pulse (Xₒᵣ) does not change when using low-resolution output signals, such as the output signals from the magnetic sensors 13, according to the present invention. The characteristic method includes: checking the state of the continuous pulse (Xₒᵣ) (S31), making the likelihood different between a case where no change occurs in the continuous pulse (Xₒᵣ) and a case where a change occurs in the continuous pulse (Xₒᵣ), that is, using the first likelihood when no change occurs in the continuous pulse (Xₒᵣ) (S32), and using the second likelihood when a change occurs in the continuous pulse (Xₒᵣ) (S33). The characteristic method is described below in greater detail. The case where no change occurs in the continuous pulse (Xₒᵣ) means that there is no change in the continuous pulse (Xₒᵣ) between previous time [k−1] and current time [k] (the state where the magnetic sensor 13 is not updated) as illustrated in FIG. 6A, and means that the motor 10 has rotated by an angle smaller than the resolution (φ) since the last change in the continuous pulse (Xₒᵣ). By contrast, the case where a change occurs in the continuous pulse (Xₒᵣ) means that there is a change in the continuous pulse (Xₒᵣ) between the previous time [k−1] and the current time [k] (the state where the magnetic sensor 13 is updated) as illustrated in FIG. 6B, and means that the motor 10 has rotated by an angle equal to or larger than the resolution (φ) since the last change in the continuous pulse (Xₒᵣ).

In the characteristic method at the likelihood evaluation step ST3, when no change occurs in the continuous pulse (Xₒᵣ) between the previous time [k−1] and the current time [k] as illustrated in FIG. 6A, the likelihood is made larger for the predicted state where the amount of rotation of the motor 10 is smaller than the resolution (φ). By contrast, the likelihood is made smaller for the predicted state where the amount of rotation of the motor 10 is equal to or larger than the resolution (φ). Specifically, the likelihood at this time is defined as the first likelihood and designed by Expression 8 below the model of which is illustrated in FIG. 7 (S32).

$${α}_{k}^{( n )} = \{ \begin{matrix}\begin{matrix}\begin{matrix}\begin{matrix}exp [ - \frac{{\{ {\hat{θ}}_{k \vert k - 1}^{( n )} - ( {\tilde{θ}}^{( n )} - Φ ) \}}^{2}}{2 {σ}^{2}} ] \\ if {\hat{θ}}_{k \vert k - 1}^{( n )} \leq {\tilde{θ}}^{( n )} - Φ ,\end{matrix} \\ 1 if {\tilde{θ}}^{( n )} - Φ < {\hat{θ}}_{k \vert k - 1}^{( n )} < {\tilde{θ}}^{( n )} + Φ ,\end{matrix} \\ exp [ - \frac{{\{ {\hat{θ}}_{k \vert k - 1}^{( n )} - ( {\tilde{θ}}^{( n )} + Φ ) \}}^{2}}{2 {σ}^{2}} ]\end{matrix} \\ if {\hat{θ}}_{k \vert k - 1}^{( n )} \geq {\tilde{θ}}^{( n )} + Φ .\end{matrix} \qquad ( Expression 8 )$$

where
α: likelihood
k: sampling time
n: index of the particle
\hat{θ}: estimated value (predicted value) of the angle
\tilde{θ}: estimated value of the angle at the moment when the signal is updated
Φ: angular resolution
σ: design parameter

In Expression 8, θ\hat{ }⁽ⁿ⁾_{k|k-1} is a predicted angle, which is calculated from the predicted state (x\hat{ }⁽ⁿ⁾_{k|k-1}) by Expression 9 below:

$${\hat{θ}}_{k \vert k - 1}^{( n )} = [ \begin{matrix}\begin{matrix}0 & 0\end{matrix} & 1\end{matrix} ] {\hat{x}}_{k \vert k - 1}^{( n )} \qquad ( Expression 9 )$$

where
k: sampling time
n: index of the particle
\hat{θ}: estimated value (predicted value) of the angle
\hat{x}: state estimated value (predicted value)

θ^{~(n)} is an estimated angle, which is an estimated value of the angle of the rotor 11 at the moment immediately after the continuous pulse (Xₒᵣ) changes. Technically speaking, as illustrated in FIG. 8, the estimated angle is an estimated value of the angle at the moment immediately after the signal is acquired when viewing the past from the previous time [k−1]. The estimated value includes values corresponding to the respective indices (n) and is estimated at the sampling time (time [k−2] in FIG. 8) at which the signal is acquired. This estimation will be described later in greater detail. φ is the resolution of the output signal of the magnetic sensor 13 and is expressed by Expression 1. In other words, the estimated angle (θ^{~(n)}±φ) is an estimated value of the angle when the motor 10 rotates by the resolution (φ) immediately after the signal changes. Therefore, as illustrated in FIG. 7, the predicted amount of rotation of the motor 10 is smaller than the resolution (φ) when the predicted angle (θ\hat{ }⁽ⁿ⁾_{k|k-1}) is inside the estimated angle (φ~⁽ⁿ⁾±φ), and it is equal to or larger than the resolution (φ) when the predicted angle (θ\hat{ }⁽ⁿ⁾_{k|k-1}) is outside the estimated angle (θ^{~(n)}±φ). Therefore, the first likelihood is made larger for the predicted state where the amount of rotation is smaller than the resolution (φ) and made smaller for the predicted state where the amount of rotation is equal to or larger than the resolution (φ). σ is a design parameter that adjusts the magnitude of the first likelihood.

In the characteristic method at the likelihood evaluation step ST3, when a change occurs in the continuous pulse (Xₒᵣ) between the previous [k−1] and the current time [k] as illustrated in FIG. 6B, the likelihood is supplied in the opposite manner to when no change occurs in the continuous pulse (Xₒᵣ) described above. In other words, the likelihood is made smaller for the predicted state where the amount of rotation of the motor 10 is smaller than the resolution (φ) but made larger for the state where the amount of rotation of the motor 10 is equal to or larger than the resolution (φ). Specifically, the likelihood at this time is defined as the second likelihood and designed by Expression 10 below the model of which is illustrated in FIG. 9 (S33). The parameters in Expression 10 are the same as those in Expression 9, so explanation thereof is omitted.

$${α}_{k}^{( n )} = \{ \begin{matrix}\begin{matrix}\begin{matrix}\begin{matrix}\begin{matrix}1 if {\hat{θ}}_{k \vert k - 1}^{( n )} \leq {\tilde{θ}}^{( n )} - Φ , \\ exp [ - \frac{{\{ {\hat{θ}}_{k \vert k - 1}^{( n )} - ( {\tilde{θ}}^{( n )} - Φ ) \}}^{2}}{2 {σ}^{2}} ]\end{matrix} \\ if {\tilde{θ}}^{( n )} - Φ < {\hat{θ}}_{k \vert k - 1}^{( n )} < {\tilde{θ}}^{( n )} ,\end{matrix} \\ exp [ - \frac{{\{ {\hat{θ}}_{k \vert k - 1}^{( n )} - ( {\tilde{θ}}^{( n )} + Φ ) \}}^{2}}{2 {σ}^{2}} ]\end{matrix} \\ if {\tilde{θ}}^{( n )} \leq {\hat{θ}}_{k \vert k - 1}^{( n )} < {\tilde{θ}}^{( n )} + Φ ,\end{matrix} \\ 1 if {\hat{θ}}_{k \vert k - 1}^{( n )} \geq {\tilde{θ}}^{( n )} + Φ .\end{matrix} \qquad ( Expression 10 )$$

where
α: likelihood
k: sampling time
n: index of the particle
\hat{θ}: estimated value (predicted value) of the angle
\tilde{θ}: estimated value of the angle at the moment when the signal is updated
Φ: angular resolution
σ design parameter

Subsequently, the likelihood (α⁽ⁿ⁾ₖ) is normalized by Expression 11 below (S401) as illustrated in FIG. 10 at the resampling and updating step ST4.

$${\overline{α}}_{k}^{( n )} = \frac{{α}_{k}^{( n )}}{{Σ}_{n = 1}^{N} {α}_{k}^{( n )}} \qquad ( Expression 11 )$$

where
k: sampling time
n: index of the particle
N: the number of particles
α: likelihood

Next, a new index is denoted as s, and the new index (s) is set to s=1 (S402). Then, a certain state predicted value (x\hat{ }^{(n′)}_{k|k-1}) is sampled with replacement from the state predicted value of the predicted state (x\hat{ }⁽¹⁾_{k|k-1}, . . . x\hat{ }^{(N)}_{k|k-1}) with a probability based on a likelihood (σ_{bar}^{(n′)}ₖ). The sampled state predicted value of the predicted state (x\hat{ }^{(n′)}_{k|k-1}) is replaced with a state estimated value of the estimated state (x\hat{ }^{(s)}ₖ) (S403).

Subsequently, an algorithm for updating the estimated angle (θ^{~(n)}) is executed. The estimated angle (θ^{~(n)}) is an estimated value of the angle of the motor 10 at the moment immediately after the continuous pulse (Xₒᵣ) changes as illustrated in FIG. 8. Therefore, the state of the continuous pulse (Xₒᵣ) is checked (S404). If no change occurs in the continuous pulse (Xₒᵣ), the estimated value is carried over to the next time. By contrast, if a change occurs in the continuous pulse (Xₒᵣ), the estimated value is re-estimated.

If no change occurs in the continuous pulse (Xₒᵣ) at the checking the state of the continuous pulse (Xₒᵣ) (S404), the estimated angle (θ^{~(n′)}) corresponding to the index (n′) is replaced with θ^{~(s)} corresponding to the index (s) (S405). Subsequently, it is checked whether s reaches the maximum value (N) of the index (S406). If s does not reach the maximum value (N) of the index, s is incremented (s is replaced by s+1) (S407), and the sampling with replacement is performed again (S403). If s reaches the maximum value (N) of the index at the checking whether s reaches the maximum value (N) of the index (S406), the system control does not return, and an estimated rotational speed acquisition step ST5, which will be described later, is performed (S408).

If a change occurs in the continuous pulse (Xₒᵣ) at the checking the state of the continuous pulse (Xₒᵣ) (S404), the estimated state (x\hat{ }^{(n′)}_{k|k-1}) at the previous sampling time corresponding to the index (n′) is replaced with a new estimated state (x^{v(s)}ₖ₋₁) corresponding to the index (n) (S409). Subsequently, it is checked whether s reaches the maximum value (N) of the index (S410). If s does not reach the maximum value (N) of the index, s is incremented (s is replaced by s+1) (S411), and the sampling with replacement is performed again (S403). If s reaches the maximum value (N) of the index at the checking whether s reaches the maximum value (N) of the index (S410), the system control does not return, and the estimated angle (θ^{~(n)}) is updated (S412). Subsequently, the estimated rotational speed acquisition step ST5, which will be described later, is performed (S413).

The values used for this update (S412) are an estimated rotational speed (ω\hat{ }⁽ⁿ⁾ₖ) at the current time [k], an estimated rotational speed (ω^{v(n)}ₖ₋₁) at the previous sampling time [k−1], and an estimated angle (θ^{v(n)}ₖ₋₁) at the previous sampling time [k−1], which are calculated by Expression 12, Expression 13, and Expression 14 below, respectively:

$${\hat{ω}}_{k}^{( n )} = [ \begin{matrix}\begin{matrix}0 & 1\end{matrix} & 0\end{matrix} ] {\hat{x}}_{k}^{( n )} , \qquad ( Expression 12 )$$

$${{ω}^{⋁}}_{k - 1}^{( n )} = [ \begin{matrix}\begin{matrix}0 & 1\end{matrix} & 0\end{matrix} ] {{x}^{⋁}}_{k - 1}^{( n )} , \qquad ( Expression 13 )$$

$${{θ}^{⋁}}_{k - 1}^{( n )} = [ \begin{matrix}\begin{matrix}0 & 0\end{matrix} & 1\end{matrix} ] {{x}^{⋁}}_{k - 1}^{( n )} , \qquad ( Expression 14 )$$

where
k: sampling time
n: index of the particle
\hat{ω}: estimated rotational speed (predicted rotational speed)
ω̌: re-estimated estimated rotational speed
\hat{x}: state estimated value (predicted value)
x̌: re-estimated state estimated value
θ̌: re-estimated estimated value of the angle

In the calculation of the estimated angle (θ^{~(n)}), it is assumed that the angular acceleration of the motor 10 is constant between the times [k−1] and [k]. Under this assumption, the estimated angle (ω^{~(n)}) is calculated by Expression 15 below, where δ is the time difference between the time immediately after the continuous pulse (Xₒᵣ) changes and the previous sampling time [k−1] as illustrated in FIG. 11, and T is the sampling time.

$${\tilde{θ}}^{( n )} = {{θ}^{⋁}}_{k - 1}^{( n )} + {{ω}^{⋁}}_{k - 1}^{( n )} δ + \frac{1}{2} \frac{{\hat{ω}}_{k}^{( n )} - {{ω}^{⋁}}_{k - 1}^{( n )}}{T} {δ}^{2} \qquad ( Expression 15 )$$

where
k: sampling time
n: index of the particle
θ̌: re-estimated estimated value of the angle
\tilde{θ}: estimated value of the angle at the moment when the signal is updated
\hat{ω}: estimated rotational speed (predicted rotational speed)
ω̌: re-estimated estimated rotational speed
δ: time difference
T: sampling period

Subsequently, the average value of the estimated state (x\hat{ }⁽ⁿ⁾ₖ) is calculated as an estimated state (x\hat{ }ₖ) by Expression 16 below at the estimated rotational speed acquisition step ST5. In addition, an estimated rotational speed (ω\hat{ }ₖ) is obtained from the estimated state (x\hat{ }ₖ) by Expression 17 below. It is checked whether to perform the next estimation (S6), that is, the operation instructions for the motor 10 are checked. If the motor 10 is not to be stopped, the time is incremented (k is replaced by k+1) (S61), and the state prediction step ST2 is performed again.

$${\hat{x}}_{k} = \frac{1}{N} {Σ}_{n = 1}^{N} {\hat{x}}_{k}^{( n )} \qquad ( Expression 16 )$$

$${\hat{ω}}_{k} = [ \begin{matrix}\begin{matrix}0 & 1\end{matrix} & 0\end{matrix} ] {\hat{x}}_{k} \qquad ( Expression 17 )$$

where
k: sampling time
n: index of the particle
N: the number of particles
\hat{x}: state estimated value (predicted value)
\hat{ω}: estimated rotational speed (predicted rotational speed)

### 2. Control Method for the Motor 10

FIG. 12 is a flowchart of a control method for the motor 10 according to the embodiment. The following describes the control method for the motor 10 using the extended particle filter 54 with reference to FIG. 12.

The control method for the motor 10 in the motor system 1 includes the rotational speed estimation method for the motor 10. The control method for the motor 10 is a method of estimating the actual rotational speed of the rotor 11 as an estimated rotational speed (ω\hat{ }) based on the outputs of the magnetic sensors 13 that detect the magnetic poles of the rotor 11 and driving and controlling the motor 10 by PID control using the estimated rotational speed (ω\hat{ }) in the motor 10 that detects the magnetic poles of the rotor 11 with the magnetic sensors 13. The control method for the motor 10 includes a target rotational speed setting step ST11 and an extended particle filter setting step ST12, and a detection pulse signal acquisition step ST13, a signal processing step ST14, a rotational speed estimation step ST15, and a motor control command step ST16, which are repeated at a constant sampling period until the drive control is stopped.

At the target rotational speed setting step ST11, a target rotational speed (ω_{ref}) for driving the brushless DC motor 10 is input and set from an input device, such as the computer device 60.

At the extended particle filter setting step ST12, specific numerical values or the like for the motor parameters in the state space model of the brushless DC motor 10 are set in the extended particle filter 54.

At the detection pulse signal acquisition step ST13, the detection pulse signals output from the respective magnetic sensors 13 are acquired at a predetermined sampling period.

At the signal processing step ST14, the continuous pulse (Xₒᵣ) is obtained by XORing the detection pulse signals acquired at each sampling time.

At the rotational speed estimation step ST15, the rotational speed of the rotor 11 is estimated from the continuous pulse (Xₒᵣ) as the estimated rotational speed (ω\hat{ }) using the extended particle filter 54. The specific method for estimating the estimated rotational speed (ω\hat{ }) by the extended particle filter 54 is described above.

At the motor control command step ST16, the control command is generated based on the estimated rotational speed (ω\hat{ }) estimated by the extended particle filter 54 and the target rotational speed (ω_{ref}) such that the motor 10 follows the target rotational speed (ω_{ref}), and the control command is output as a drive control signal for the motor 10.

### 3. Functions and Advantageous Effects

The rotational speed estimation method for the motor 10 according to the embodiment is a method of estimating the actual rotational speed of the rotor 11 from the continuous pulses (Xₒᵣ) processed based on the outputs of the magnetic sensors 13 that detect the magnetic poles of the rotor 11, and uses the extended particle filter 54 as a filter. In this method, the extended particle filter setting step ST12 is performed to set, to the extended particle filter 54, a plurality of likelihoods selectively applied based on whether a change occurs in the outputs of the magnetic sensors 13. Then, the detection pulse signal acquisition step ST13 is performed to acquire the detection pulse signals output from the magnetic sensors 13 at a predetermined sampling period, and the signal processing step ST14 is performed to obtain the continuous pulse (Xₒᵣ) from the detection pulse signals acquired at each sampling time. This method uses the extended particle filter 54 to apply the first likelihood when no change occurs in the continuous pulse (Xₒᵣ) and apply the second likelihood when a change occurs in the continuous pulse (Xₒᵣ). Thus, the rotational speed estimation step ST15 is performed to estimate the rotational speed of the rotor 11 as the estimated rotational speed (ω\hat{ }). In other words, this method does not use a rotary encoder or a detected current value to estimate the rotational speed of the motor 10. In this method, the rotational speed of the motor 10 is estimated by applying the first likelihood designed to be adapted to the estimation of a section having no magnetic sensor signal during low-speed rotation of the motor 10 when the estimation accuracy tends to deteriorate in the conventional technology. Therefore, this method enables estimating the rotational speed of the motor 10 with high accuracy from the time of low-speed rotation based on the information obtained by observation by the magnetic sensors 13 without using a rotary encoder or a detected current value.

In this method, the first likelihood is designed to be made larger for the predicted state where the amount of rotation of the rotor 11 is smaller than the resolution (φ) and made smaller for the predicted state where the amount of rotation of the rotor 11 is equal to or larger than the resolution (φ). The second likelihood is designed to be made smaller for the predicted state where the amount of rotation of the rotor is smaller than the resolution (φ) and made larger for the predicted state where the amount of rotation of the rotor is equal to or larger than the resolution (φ). Specifically, the first likelihood is designed by Expression 8 above, and the second likelihood is designed by Expression 10 above. Designing these likelihoods in this manner can provide the extended particle filter 54 that can be adapted to low-speed rotation as well as normal rotation.

In this method, the rotational speed estimation step ST15 includes: normalizing the likelihood (φ⁽ⁿ⁾ₖ), sampling with replacement a certain state predicted value (x\hat{ }^{(n′)}_{k|k-1}) from the state predicted value of the predicted state {x\hat{ }⁽¹⁾_{k|k-1}, . . . x\hat{ }^{(N)}_{k|k-1}} with the probability based on the normalized likelihood (α_{bar}^{(n′)}ₖ), and replacing the certain state predicted value (x\hat{ }^{(n′)}_{k|k-1}) sampled with replacement with the state estimated value of the estimated state (x\hat{ }^{(s)}ₖ); and updating the estimated angle (θ^{~(n)}) serving as the estimated value of the angle of the rotor 11 at the moment immediately after a change occurs in the continuous pulse (Xₒᵣ). In this method, if no change occurs in the continuous pulse (Xₒᵣ), the estimated angle (θ^{~(n)}) is updated by being carried over to the next time at the updating the estimated angle (θ^{~(n)}). If a change occurs in the continuous pulse (Xₒᵣ), the estimated angle (θ^{~(n)}) is updated by replacing it with the estimated value of the angle at the moment when the change occurs. By sampling with replacement the state estimated value (x\hat{ }^{(n′)}_{k|k-1}) and updating the estimated angle (θ^{~(n)}) in this manner, this method enables keeping the first likelihood always adapted to low-speed rotation when no change occurs in the continuous pulse (Xₒᵣ).

The control device 20 of the motor 10 according to the embodiment includes the extended particle filter 54 having the estimation algorithm required to perform the rotational speed estimation method for the motor 10 described above. Therefore, the control device 20 enjoys the advantageous effects of the rotational speed estimation method for the motor 10 described above and can estimate the rotational speed of the motor 10 with high accuracy from the time of low-speed rotation based on the information obtained by observation by the magnetic sensors 13 without using a detected current value. As a result, the control device 20 can control the motor 10 to follow the target rotational speed (ω_{ref}) with high accuracy from the time of low-speed rotation.

### Other Embodiments

While the present invention has been described based on the embodiment above, the invention is not limited to the embodiment above. The present invention can be implemented in various forms without departing from the scope of the invention, and the following modifications, for example, can be made.

(1) The number of components, the way of coupling, the setting parameters of the extended particle filter, and the like described in the embodiment above are given by way of example only and can be modified within a range not impairing the advantageous effects of the present invention.

(2) In the embodiment above, the control device 20 of the motor 10 is a device in which the motor driver 30, the motor drive power supply 40, and the DSP unit 50 are integrated, but the present invention is not limited thereto. For example, some of the components may be configured as a separate device electrically coupled to the control device.

(3) In the embodiment above, the motor 10 is a four-pole three-phase motor, but the present invention is not limited thereto. For example, the motor 10 may be a two-pole (divided into two equal parts at 1800) three-phase motor with two magnetic poles arranged in the rotor 11.

(4) In the embodiment above, the control command from the DSP unit 50 is based on PID control, but the present invention is not limited thereto. The present invention is also applicable to a system in which the control command from the DSP unit is based on feedback control, such as I-PD control and PI-PD control.

(5) While the embodiment above has described the rotational speed estimation method using the brushless DC motor system 1 with a rotational speed control system illustrated in FIG. 2 as an example, the rotational speed estimation method according to the present invention is not necessarily applied to a brushless DC motor system the speed of which is controlled. For example, the present invention is also applicable to a brushless DC motor system the position of which is controlled.

### EXAMPLES

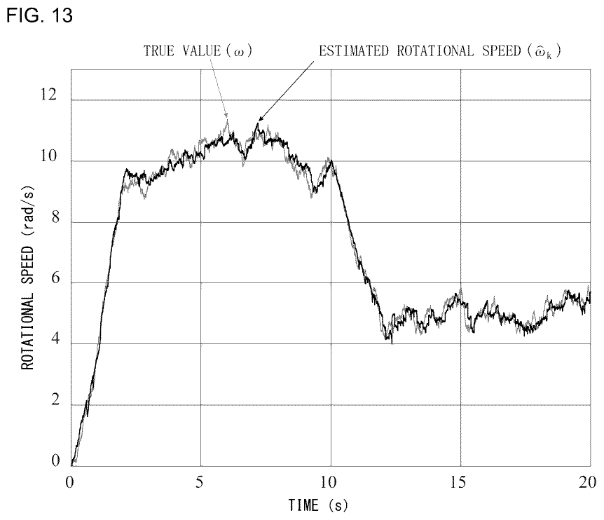

FIG. 13 is a graph indicating the simulation results of estimation of the rotational speed of the motor 10 using the extended particle filter 54. The following describes a simulation performed to verify the advantageous effects of the extended particle filter 54 according to the embodiment with referent to FIG. 13.

The parameters of a motor model set in this simulation are indicated in Table 1 below. The variance of system noise vₖ was set to σᵥ²=0.4. The number of particles in the extended particle filter 54 was set to N=100, and the initial values of the estimated state {x\hat{ }⁽¹⁾₀, . . . , x\hat{ }^{(N)}₀} were all set to zero vector (x\hat{ }⁽ⁿ⁾₀=[0 0]^{T}). The motor 10 has a small number of magnetic poles M (M=4), and the resolution (φ) is φ=30 [deg] from Expression 1, which is sufficiently low resolution.

TABLE 1

| | Value | Unit |
|---|---|---|
| J | 7.1 × 10⁻⁴ | kgm² |
| R | 1.6 | Ω |
| L | 5.2 × 10⁻⁴ | H |
| K_{τ} | 0.020 | N · m/A |
| Kₑ | 0.020 | Vs/rad |
| D | 1.0 × 10⁻⁸ | N · m/(rad/s) |

As a result of a 20-second simulation performed under these conditions, the estimated rotational speed illustrated in FIG. 13 is obtained. In FIG. 13, the motor 10 is rotating at low speed, and estimation is significantly affected by the low resolution of the magnetic sensors 13. In the simulation results illustrated in FIG. 13, when the rotational speed of the motor 10 was estimated using the extended particle filter 54, the root mean squared error (RMSE) of the estimated value was 0.2737. Based on the simulation results, it was found out that the estimated rotational speed was close to the true rotational speed and that the rotational speed was able to be estimated with high accuracy during low-speed rotation using the extended particle filter 54 to which the developed algorithm according to the present invention was applied to estimate the rotational speed of the motor 10. Therefore, the effectiveness of the extended particle filter 54 to which the developed algorithm according to the present invention was applied was verified.

What is claimed is:

1. A rotational speed estimation method for a brushless DC motor for estimating an actual rotational speed of a rotor by passing an output of a plurality of magnetic sensors configured to detect magnetic poles of the rotor through a filter, the rotational speed estimation method comprising:
an extended particle filter setting step of using an extended particle filter to which a plurality of likelihoods is capable of being set as the filter, and setting, as the plurality of likelihoods, at least a first likelihood and a second likelihood selectively applied based on whether a change occurs in the output of the plurality of magnetic sensors to the extended particle filter, the first likelihood being adapted to a case where no change occurs in the output of the plurality of magnetic sensors and the second likelihood being adapted to a case where a change occurs in the output of the plurality of magnetic sensors;
a detection pulse signal acquisition step of acquiring a detection pulse signal output from each of the plurality of magnetic sensors at a predetermined sampling period;
a signal processing step of obtaining a continuous pulse by exclusive-ORing (XORing) the detection pulse signal acquired at each sampling time; and
a rotational speed estimation step of using the extended particle filter to which the plurality of likelihoods is set, applying the first likelihood as a likelihood of the extended filter when no change occurs in the continuous pulse and applying the second likelihood as the likelihood of the extended particle filter when a change occurs in the continuous pulse, and estimating a rotational speed of the rotor.

2. The rotational speed estimation method for a brushless DC motor according to claim 1, wherein, when an angle of one pulse width of the continuous pulse is resolution, and a state of the motor in which a rotational angle of the rotor is predicted is a predicted state,
the first likelihood is designed to be made larger for the predicted state where an amount of rotation of the rotor is smaller than the resolution and made smaller for the predicted state where the amount of rotation of the rotor is equal to or larger than the resolution from a point immediately after a change occurs in the continuous pulse, and
the second likelihood is designed to be made smaller for the predicted state where the amount of rotation of the rotor is smaller than the resolution and made larger for the predicted state where the amount of rotation of the rotor is equal to or larger than the resolution from the point immediately after the change occurs in the continuous pulse.

3. The rotational speed estimation method for a brushless DC motor according to claim 2, wherein the first likelihood is designed by Expression 8 below, and the second likelihood is designed by Expression 10 below:
$${α}_{k}^{( n )} = \{ \begin{matrix}\begin{matrix}\begin{matrix}\begin{matrix}exp [ - \frac{{\{ {\hat{θ}}_{k \vert k - 1}^{( n )} - ( {\tilde{θ}}^{( n )} - Φ ) \}}^{2}}{2 {σ}^{2}} ] \\ if {\hat{θ}}_{k \vert k - 1}^{( n )} \leq {\tilde{θ}}^{( n )} - Φ ,\end{matrix} \\ 1 if {\tilde{θ}}^{( n )} - Φ < {\hat{θ}}_{k \vert k - 1}^{( n )} < {\tilde{θ}}^{( n )} + Φ ,\end{matrix} \\ exp [ - \frac{{\{ {\hat{θ}}_{k \vert k - 1}^{( n )} - ( {\tilde{θ}}^{( n )} + Φ ) \}}^{2}}{2 {σ}^{2}} ]\end{matrix} \\ if {\hat{θ}}_{k \vert k - 1}^{( n )} \geq {\tilde{θ}}^{( n )} + Φ .\end{matrix} \qquad ( Expression 8 )$$
wherein
α represents a likelihood, k represents a sampling time, n represents an index of a particle, \hat{θ} represents an estimated value (predicted value) of an angle, \tilde{θ} represents an estimated value of an angle at a moment when a signal is updated, Φ represents an angular resolution, and σ represents a design parameter; and
$${α}_{k}^{( n )} = \{ \begin{matrix}\begin{matrix}\begin{matrix}\begin{matrix}\begin{matrix}1 if {\hat{θ}}_{k \vert k - 1}^{( n )} \leq {\tilde{θ}}^{( n )} - Φ , \\ exp [ - \frac{{\{ {\hat{θ}}_{k \vert k - 1}^{( n )} - ( {\tilde{θ}}^{( n )} - Φ ) \}}^{2}}{2 {σ}^{2}} ]\end{matrix} \\ if {\tilde{θ}}^{( n )} - Φ < {\hat{θ}}_{k \vert k - 1}^{( n )} < {\tilde{θ}}^{( n )} ,\end{matrix} \\ exp [ - \frac{{\{ {\hat{θ}}_{k \vert k - 1}^{( n )} - ( {\tilde{θ}}^{( n )} + Φ ) \}}^{2}}{2 {σ}^{2}} ]\end{matrix} \\ if {\tilde{θ}}^{( n )} \leq {\hat{θ}}_{k \vert k - 1}^{( n )} < {\tilde{θ}}^{( n )} + Φ ,\end{matrix} \\ 1 if {\hat{θ}}_{k \vert k - 1}^{( n )} \geq {\tilde{θ}}^{( n )} + Φ .\end{matrix} \qquad ( Expression 10 )$$
wherein
α represents a likelihood, k represents a sampling time, n represents an index of a particle, \hat{θ} represents an estimated value (predicted value) of an angle, \tilde{θ} represents an estimated value of an angle at a moment when a signal is updated, Φ represents an angular resolution, and σ represents a design parameter.

4. The rotational speed estimation method for a brushless DC motor according to claim 1, wherein
the rotational speed estimation step includes:
normalizing the likelihood, sampling with replacement a certain state predicted value from a state predicted value of the predicted state with a probability based on the normalized likelihood, and replacing the certain state predicted value sampled with replacement with a state estimated value of an estimated state; and
updating an estimated angle serving as an estimated value of an angle of the rotor at a moment immediately after a change occurs in the continuous pulse.

5. The rotational speed estimation method for a brushless DC motor according to claim 4, wherein, when no change occurs in the continuous pulse, the estimated angle is updated by being carried over to next time at the updating the estimated angle, and when a change occurs in the continuous pulse, the estimated angle is updated by being replaced with the estimated value of the angle at the moment when the change occurs.

6. A control device for a brushless DC motor coupled to the brushless DC motor including a plurality of magnetic sensors that detects and output magnetic poles of a rotor, and configured to drive and control the brushless DC motor, the control device comprising:
a motor driver configured to drive and rotate the rotor at a target rotational speed based on a control command;
a detection pulse signal acquirer configured to acquire a detection pulse signal output from each of the plurality of magnetic sensors at a predetermined sampling period;
a signal processor configured to obtain a continuous pulse by exclusive-ORing (XORing) the detection pulse signal acquired at each sampling time;
an extended particle filter designed to have at least a first likelihood and a second likelihood selectively applied based on whether a change occurs in the continuous pulse as a likelihood, and configured to apply the first likelihood as the likelihood when no change occurs in the continuous pulse and apply the second likelihood as the likelihood when a change occurs in the continuous pulse and to estimate a rotational speed of the rotor as an estimated rotational speed; and
a motor control commander configured to generate the control command based on the estimated rotational speed estimated by the extended particle filter and the target rotational speed to cause the rotor to follow the target rotational speed and output the control command to the motor driver.

7. The control device for a brushless DC motor according to claim 6, wherein, when an angle of one pulse width of the continuous pulse is resolution, and a state of the motor in which a rotational angle of the rotor is predicted is a predicted state,
the first likelihood is designed to be made larger for the predicted state where an amount of rotation of the rotor is smaller than the resolution and made smaller for the predicted state where the amount of rotation of the rotor is equal to or larger than the resolution from a point immediately after a change occurs in the continuous pulse, and
the second likelihood is designed to be made smaller for the predicted state where the amount of rotation of the rotor is smaller than the resolution and made larger for the predicted state where the amount of rotation of the rotor is equal to or larger than the resolution from the point immediately after the change occurs in the continuous pulse.

8. The control device for a brushless DC motor according to claim 7, wherein the first likelihood of the extended particle filter is designed by Expression 8 below, and the second likelihood of the extended particle filter is designed by Expression 10 below:
$${α}_{k}^{( n )} = \{ \begin{matrix}\begin{matrix}\begin{matrix}\begin{matrix}exp [ - \frac{{\{ {\hat{θ}}_{k \vert k - 1}^{( n )} - ( {\tilde{θ}}^{( n )} - Φ ) \}}^{2}}{2 {σ}^{2}} ] \\ if {\hat{θ}}_{k \vert k - 1}^{( n )} \leq {\tilde{θ}}^{( n )} - Φ ,\end{matrix} \\ 1 if {\tilde{θ}}^{( n )} - Φ < {\hat{θ}}_{k \vert k - 1}^{( n )} < {\tilde{θ}}^{( n )} + Φ ,\end{matrix} \\ exp [ - \frac{{\{ {\hat{θ}}_{k \vert k - 1}^{( n )} - ( {\tilde{θ}}^{( n )} + Φ ) \}}^{2}}{2 {σ}^{2}} ]\end{matrix} \\ if {\hat{θ}}_{k \vert k - 1}^{( n )} \geq {\tilde{θ}}^{( n )} + Φ .\end{matrix} \qquad ( Expression 8 )$$
wherein
α represents a likelihood, k represents a sampling time, n represents an index of a particle, \hat{θ} represents an estimated value (predicted value) of an angle, \tilde{θ} represents an estimated value of an angle at a moment when a signal is updated, Φ represents an angular resolution, and σ represents a design parameter; and
$${α}_{k}^{( n )} = \{ \begin{matrix}\begin{matrix}\begin{matrix}\begin{matrix}\begin{matrix}1 if {\hat{θ}}_{k \vert k - 1}^{( n )} \leq {\tilde{θ}}^{( n )} - Φ , \\ exp [ - \frac{{\{ {\hat{θ}}_{k \vert k - 1}^{( n )} - ( {\tilde{θ}}^{( n )} - Φ ) \}}^{2}}{2 {σ}^{2}} ]\end{matrix} \\ if {\tilde{θ}}^{( n )} - Φ < {\hat{θ}}_{k \vert k - 1}^{( n )} < {\tilde{θ}}^{( n )} ,\end{matrix} \\ exp [ - \frac{{\{ {\hat{θ}}_{k \vert k - 1}^{( n )} - ( {\tilde{θ}}^{( n )} + Φ ) \}}^{2}}{2 {σ}^{2}} ]\end{matrix} \\ if {\tilde{θ}}^{( n )} \leq {\hat{θ}}_{k \vert k - 1}^{( n )} < {\tilde{θ}}^{( n )} + Φ ,\end{matrix} \\ 1 if {\hat{θ}}_{k \vert k - 1}^{( n )} \geq {\tilde{θ}}^{( n )} + Φ .\end{matrix} \qquad ( Expression 10 )$$
wherein
α represents a likelihood, k represents a sampling time, n represents an index of a particle, \hat{θ} represents an estimated value (predicted value) of an angle, \tilde{θ} represents an estimated value of an angle at a moment when a signal is updated, Φ represents an angular resolution, and σ represents a design parameter.

9. The control device for a brushless DC motor according to claim 6, wherein
the extended particle filter is designed to perform:
normalizing the likelihood, sampling with replacement a certain state predicted value from a state predicted value of the predicted state with a probability of the normalized likelihood, and replacing the certain state predicted value sampled with replacement with a state estimated value of an estimated state; and
updating an estimated angle serving as an estimated value of an angle of the rotor at a moment immediately after a change occurs in the continuous pulse.

10. The control device for a brushless DC motor according to claim 9, wherein, when no change occurs in the continuous pulse, the extended particle filter updates the estimated angle by carrying over the estimated angle to next time at the updating the estimated angle, and when a change occurs in the continuous pulse, the extended particle filter updates the estimated angle by replacing the estimated angle with the estimated value of the angle at the moment when the change occurs.
